(19) United States
(12) Patent Application Publication
(10) Pub. No.: US 2004/0159510 A1
(43) Pub. Date: Aug. 19, 2004

(54) Unitary drop case and caliper housing assembly

(75) Inventors: Ron Bergman, McIntosh, MN (US); Bryce Abrahamson, Holt, MN (US)

Correspondence Address: MERCHANT & GOULD PC, P.O. BOX 2903, MINNEAPOLIS, MN, 55402-0903, US

(73) Assignee: Arctic Cat Inc., Thief River Falls, MN

(21) Appl. No.: 10/291,093

(22) Filed: Nov. 7, 2002

(51) Int. Cl. F16D 65/12

(52) U.S. Cl. 188/218 XL

(57) ABSTRACT

A unitary drop case and caliper housing for a personal recreational vehicle is disclosed. The housing includes a caliper housing section and a drop case section. The drop case section includes an interior section and an outer wall. The caliper housing section extends from the outer wall of the drop case section. The caliper housing section secures a braking arrangement. The braking arrangement includes brake pads for engaging a braking disc mounted on a bearing in the drop case section. The braking disc is connected to a track shaft. The drop case section includes openings for receiving a bearing assembly. A first bearing assembly connects to a track shaft. A second bearing assembly connects to a drive shaft. The track and drive shafts are coupled via a driving chain in the drop case section. The drop case section also receives a cover for sealing the interior section of the drop case.

### FIELD OF THE INVENTION

The invention relates generally to drive trains for personal recreational vehicles, and more particularly to an improved unitary drop case and caliper housing assembly for use with a drive train in snowmobiles.

### BACKGROUND OF THE INVENTION

Personal recreational vehicles, such as snowmobiles and ATVs, are used by millions of people for sport and fun. To illustrate, snowmobiling is a sport enjoyed by individuals of all ages and walks of life. Although interest in snowmobiling has traditionally been considerable, in recent years the sport has seen its popularity soar. For example, according to the International Snowmobile Manufacturers Association, about 82,000 snowmobiles were sold in the United States in 1992. By 1997, that number topped 170,000 units.

Similarly, the number of Americans driving off-road vehicles such as ATVs increased from 19.4 million in 1983 to 27.9 million in 1995. The increase in use of personal recreational vehicles is partly due to technological advancements of the equipment, advances that have made use safer and easier for persons of differing levels of ability.

For example, snowmobiles have become more comfortable, responsive and maneuverable, resulting in a more pleasing and exciting riding experience for the driver. One advancement of particular importance is the improvement in the maneuverability and stability of snowmobiles. As these characteristics have advanced, a greater number of individuals have been drawn to the sport. The industry has kept pace with the growth in the sport by expanding the number of models available across a range of prices. ATVs have seen similar types of improvements.

Brake caliper arrangements for snowmobiles generally include the brake disc on the driven shaft. This arrangement is located relatively high in the vehicle relative and creates a high center of gravity due to the mass of the brake arrangement and because the brake arrangement is typically located on the driven shaft.

To improve performance of a snowmobile, it is desirable that the center of gravity of the snowmobile be as low as possible. It is also desirable to make the same improvements in other types of personal recreational vehicles. For the reasons stated and others, improvements in the brake arrangement are desired.

### SUMMARY OF THE INVENTION

One aspect of the present invention is directed to a unitary drop case and brake assembly for a personal recreational vehicle. The unitary assembly includes a unitary housing having a drop case section and a caliper housing section. The drop case section includes a wall separating an interior section and an exterior surface. The caliper housing section extends outwardly from the exterior surface of the wall. The drop case and caliper housing sections are formed into an integral unit.

Another aspect of the present invention is directed to a snowmobile including a chassis having a tunnel section. The tunnel section includes first and second opposed walls, and the walls form an interior section therebetween. An opening is located in the first wall. The vehicle also includes a unitary housing having a drop case section and a caliper housing section mounted to the chassis. The unitary housing is mounted on the first wall such that the drop case section is outside the interior section of the tunnel. The caliper housing is received through the opening in the first wall and is inside the tunnel section.

### BRIEF DESCRIPTION OF THE DRAWINGS

The invention may be more completely understood in consideration of the following detailed description of various embodiments of the invention in connection with the accompanying drawings, in which:

FIG. 1 is a side view of a snowmobile of a type that can incorporate an example embodiment of the unitary housing of the present invention.

FIG. 2 is a partial cut away perspective view of an example embodiment of a unitary housing of the present invention coupled to a snowmobile chassis.

FIG. 3 a partial cut away perspective view of the unitary housing mounted to the snowmobile chassis of FIG. 2.

FIG. 4 is an exploded perspective view a drive and brake assembly useful in a vehicle having a drop-in brake case and caliper assembly in a unitary fashion according to the present disclosure.

FIG. 5 is a perspective view of an example embodiment of a drop case and caliper unitary housing assembly coupled to a track shaft.

FIG. 6 is an exploded perspective view of an example embodiment of a drop case and caliper unitary housing assembly.

FIG. 7 is another perspective view of the unitary housing assembly of FIG. 6.

FIG. 8 is another perspective view of the unitary housing assembly of FIG. 6.

FIG. 9 is a perspective view of a cover for a unitary housing assembly.

FIG. 10A is a perspective view of an example embodiment of a drop case and caliper unitary housing assembly with the brake disc removed.

FIG. 10B is a perspective view of the unitary housing assembly of FIG. 10A including the braking disc.

FIG. 10C is a top view of the housing of FIG. 10B.

FIG. 10D is an elevation view of the housing of FIG. 10C.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION OF THE INVENTION

In the following description of preferred embodiments of the present disclosure, reference is made to the accompanying drawings that form a part hereof, and in which is shown by way of illustration specific embodiments in which the disclosure might be practiced. It is understood that other embodiments may be utilized and structural changes may be made without departing from the scope of the present invention.

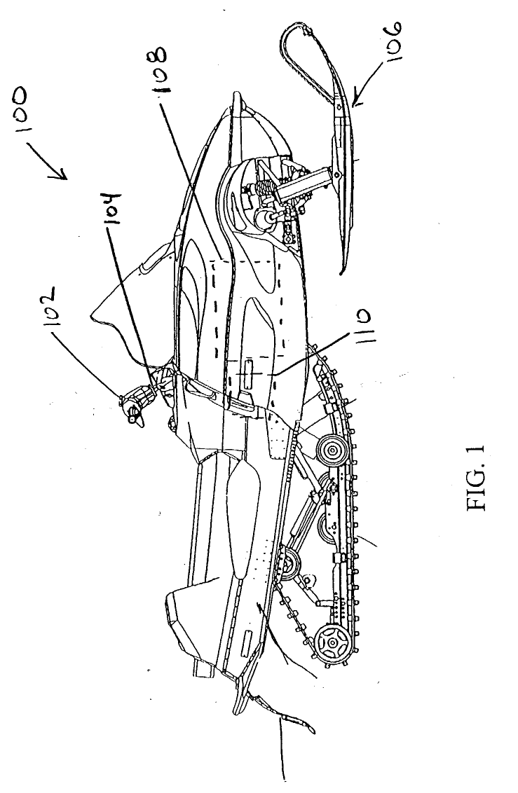

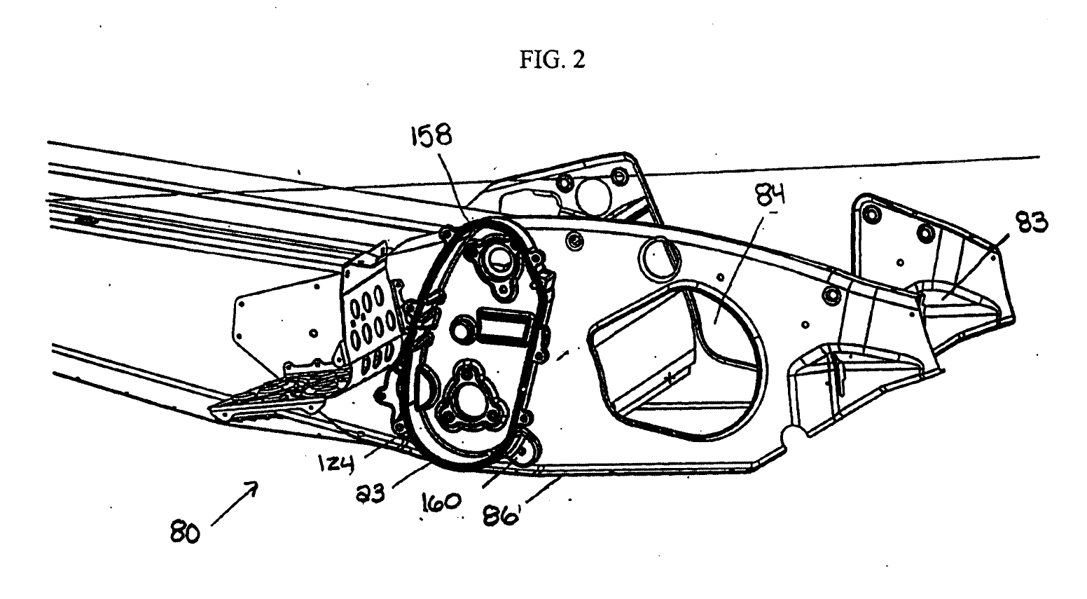

FIGS. 1-2 depict a personal recreational vehicle, a snowmobile 100, with a steering mechanism 102 that controls the orientation of a set of front skis 106 via a steering shaft 104. The steering shaft 104 couples the steering mechanism 102 with the front skis 106 via tie rods (not shown) that connect the steering shaft 104 to the suspension system (not shown) of the front skis 106. The details regarding the coupling of the steering shaft 104 and the suspension system for the skis 106 vary from snowmobile to snowmobile and are known and are not the focus of the present invention. Therefore, they are not discussed further.

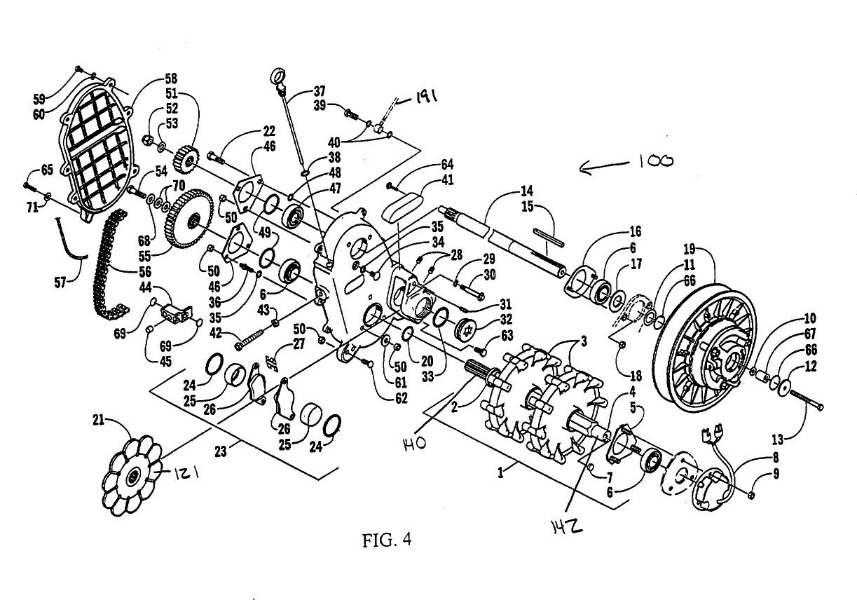

As the steering mechanism 102 is turned, the front skis 106 also turn, thereby controlling the direction in which the snowmobile 100 moves. An engine 108 is mounted toward the front of the chassis of the snowmobile 100. The engine provides power to the drive train (shown in FIG. 4) of the snowmobile 100. The details of the drive train vary from snowmobile to snowmobile, but according to the present invention, the snowmobile will have a drop case and caliper unitary housing assembly 110 to allow for transmitting power from the engine to the tracks 118 and also allow for slowing and stopping of the snowmobile when the brakes are applied. The unitary housing assembly will typically be located on a portion of the drive train of the snowmobile near the tracks. However, the location can vary depending on the snowmobile. Similarly, the unitary housing assembly of the present disclosure can be used on an ATV, and its use and placement are dictated by considerations similar to those in using the power distribution in a snowmobile.

Referring to FIGS. 1-3, a portion of a snowmobile chassis 80 is shown. The snowmobile chassis 80 has tunnel portion 81 and an outer portion 82. The tunnel portion 81 is located under a seat where a rider would sit when operating the snowmobile. The tunnel 81 also houses drive train components. The tunnel portion 81 is isolated from the underhood 83 and engine compartments 84 (not shown), which generally house the engine and electronic components of the snowmobile.

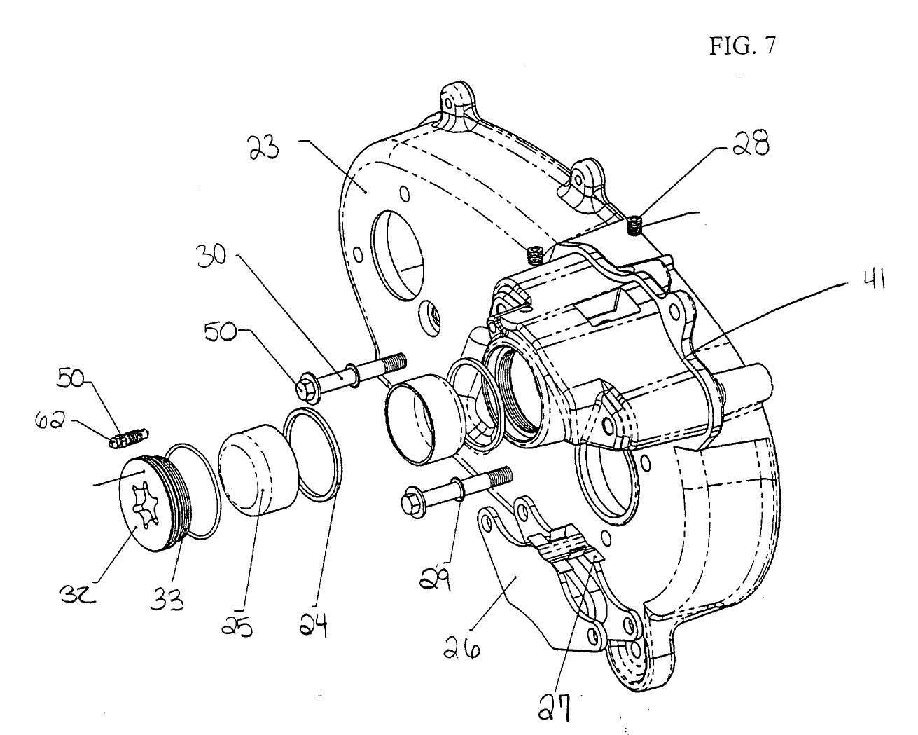

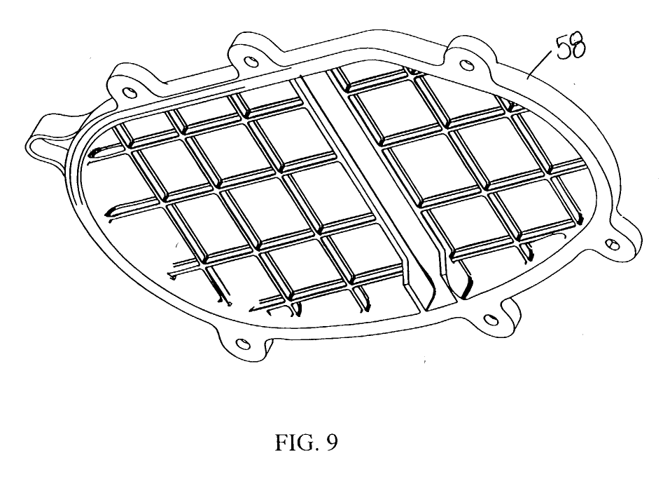

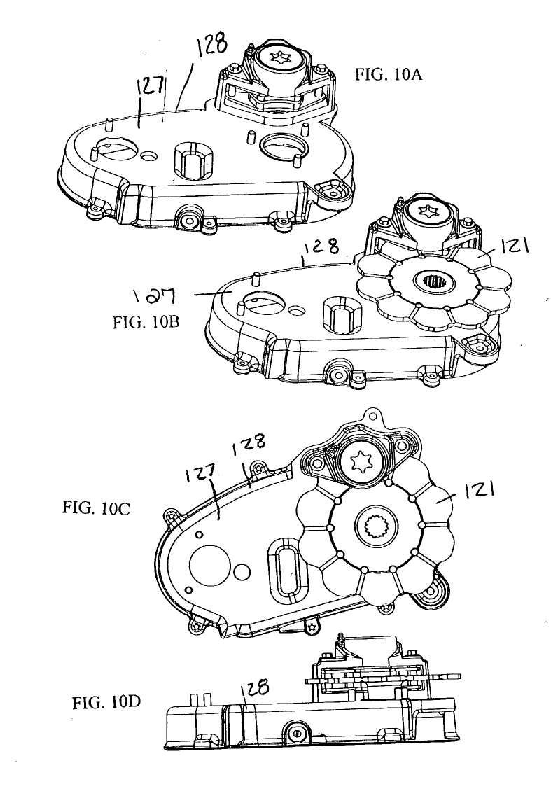

Referring to FIGS. 2-4, 7-8 and 10A-D, a unitary housing 23 is fastened to the outer face 85 of the chassis wall 86. The unitary housing 23 includes a drop case section 124 and a caliper housing section 125. The drop case section 124 includes an interior section 126 and an exterior surface section 127 and a wall 128 therebetween. The interior section 126 houses drive train components (FIG. 4). The drop case 124 houses gears or sprockets 51, 55 that transfer power from the clutch shaft to the track shaft. A cover 58 (shown in FIG. 9) cooperates with a cover receiving section 158 on the drop case 124 to seal interior section 126 and keep components located in the interior section 126 protected from the elements and to keep lubricant sealed in.

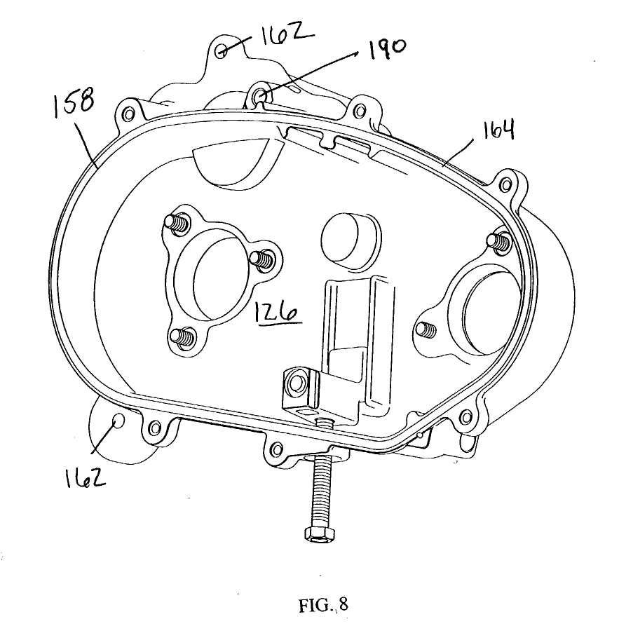

The drop case 124 is attached to the chassis 80 wall 86 in the outer portion 82 of the tunnel. The housing 23 includes flanges 160 on the drop case 124 with openings 162 for receiving a fastener 50. The drop case 124 is attached to the outer wall 85 of the chassis 80 with a fastener arrangement, for example, nuts 62 and bolts 50, wherein a fastener 50 is received through its respective flange opening 162 and also passes through the outer wall 85 of the chassis 80. Each fastener 50 is then secured in place. The drop case 124 also includes a sealing channel 164 for receiving a sealing member, for example, a gasket. The sealing member is held between the sealing channel 164 (shown in FIG. 8) and the cover 58 when the cover 58 is attached to the drop case 124, thereby forming a seal to keep dirt and other residue out of the interior section 126.

Referring to FIGS. 2-4, 6, and 10A-D, an opposite perspective view of the chassis 80 of FIG. 2 is shown. The brake caliper housing 125 extends from the exterior wall 127 of the drop case (not shown) and through an opening 129 in the chassis 80 into the tunnel section 81. When the drop case 124 is attached to the chassis 80, the brake caliper housing 125 protrudes into the tunnel 81. The brake caliper housing 125 holds a brake pad arrangement 150 in place. The brake pad arrangement 150 includes first and second opposed brake pads 26, and first and second pistons 25 arranged around the first and second brake pads 26. The first and second pistons 25 urge the brake pads 26 towards one another when a braking force is applied. An end cap 32 holds the pistons 25 in place and a pair of mounting fasteners 30 hold the brake pads 26 in place.

Referring to FIGS. 4, 9 & 10A-D, a braking disc 21 is coupled to a bearing assembly 6 in the drop case 124. The braking disc 21 includes a portion 121 that passes between the opposed brake pads 26. When it is desired to slow or stop the vehicle, the brake master cylinder (not shown) creates a force that is transmitted to the pad arrangement 50. The pistons 25 move the opposed brake pads 26 inwardly towards one another. The brake pads 26 engage the braking disc 21, thereby slowing or stopping its rotation. The track shaft 4 is attached to the braking disc 21. The track shaft 4 is also attached to a bearing assembly 6 mounted on the chassis 80. The track shaft 4 drives a track (not shown), connected to the track sprockets 3, propeling the vehicle. An advantage of the brake disc 21 being coupled directly to the track shaft 4 is that braking control is improved.

Referring to FIGS. 1A and 4, a drive train assembly 100 for a personal recreational vehicle is shown. The drive train 100 includes a driven clutch 19. The driven clutch 19 is driven by a driving clutch (not shown), which is located on the engine (not shown) and the driven clutch 19, and transmits power therebetween. The driven clutch 19 includes a clutch shaft 14 that passes through a clutch shaft opening 102 in the drop case 23. The clutch shaft 14 is received into and passes through a bearing 47 in the clutch shaft opening 101 in the drop case 23. The clutch shaft 14 has a first sprocket 51 mounted on the end of the clutch shaft 14 housed in the drop case 23. The first sprocket 51 drives a driving chain or belt 56, which is also in communication with a second sprocket 55 housed in the drop case 23. The second sprocket 55 is directly coupled to a first end of the track shaft 4. The track shaft 4 drives the tracks of the vehicle, which in turn propels the vehicle.

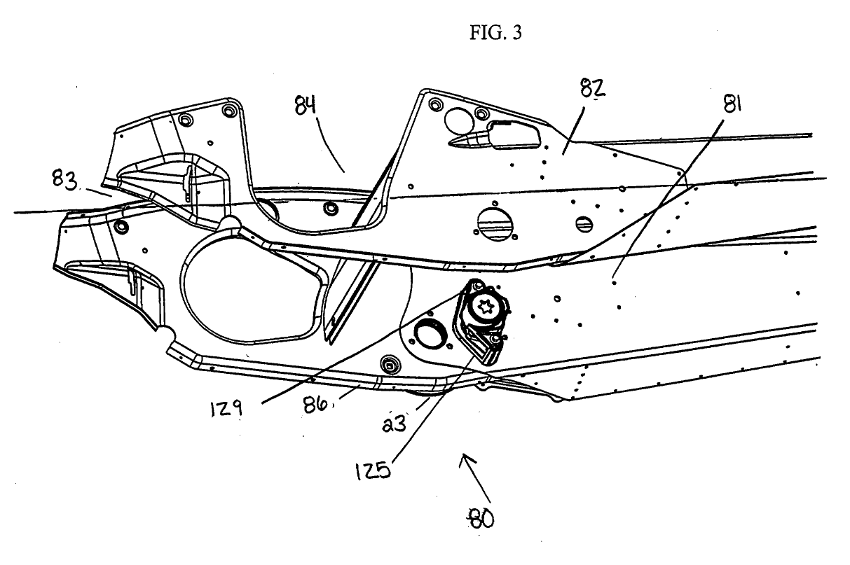

Referring to FIGS. 3, 4, 6, 8 and 10A-D, a unitary drop case/caliper housing 23 is shown. The housing 23 houses drive components that are coupled to the driven clutch assembly 19 (as shown in FIG. 4). The caliper housing 125 and case 124 are formed from a unitary molded unit. The brake caliper housing 125, which is located in the tunnel 181 in FIG. 3, engages a brake disc 21. Engagement of the brake disc 21 slows and eventually stops the vehicle during operation. The brake disc 21 is coupled to the track shaft 4. The track shaft 4 engages and drives the drive belt or chain that propels the snowmobile during operation. The track shaft 4 has a first end 140 and a second end 142. The first end 140 is engaged in the drop case 124 through a bearing 6, which allows the shaft 4 to rotate. The second end 142 is held in place by a bearing 6 that cooperates with the tunnel 81 wall 86 opposite the drop case 124.

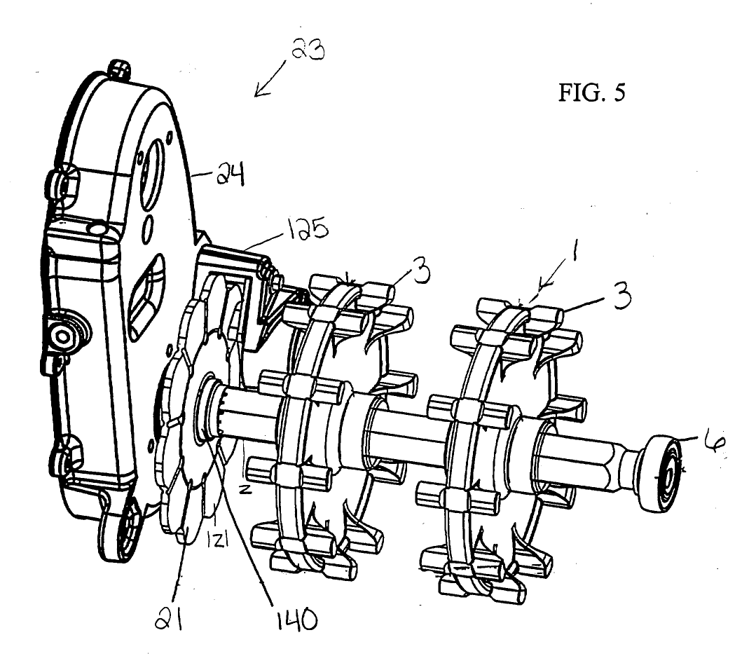

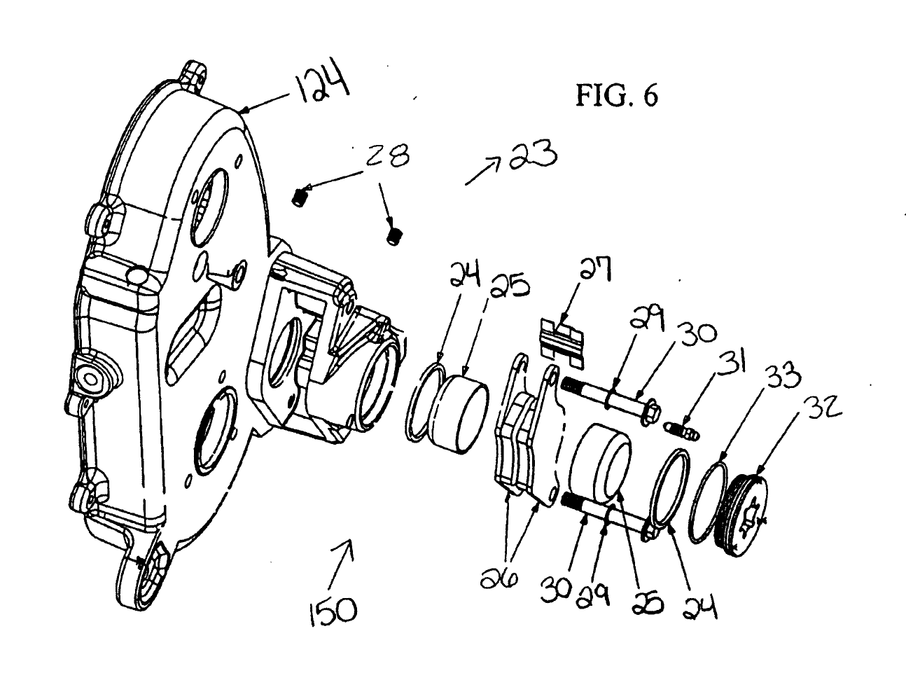

Referring to FIGS. 5, 7 and 12, the unitary drop case/brake caliper housing is preferably formed by casting. Preferably, the drop case/brake caliper assembly is made from aluminum; however, one of skill in the art will recognize that other materials may be used, such as case steel. The caliper housing section is machined to create openings for receiving the bolts 30 that hold the brake pads 26 in place. A fluid channel is also machined into the caliper housing for connection to the brake line assembly (39, 40, 191 in FIG. 4). The brake line assembly connects to the fluid channel of the caliper housing at a brake line connection opening 190 (shown in FIG. 6). The fluid channel also is plugged at the opposite end with a bleed valve 31 (shown in FIG. 4). The end cap and seal secure the pistons and fluid in the caliper housing. An advantage of the method of the present disclosure is that the caliper housing can be machined from one side, preferably from the face of the caliper housing positioned away from the drop case.

An advantage of the present invention is that by locating the brake caliper housing and braking disc in the tunnel, any dust or debris generated by engagement of the brake pads with the braking disc does not reach and is kept from the engine and under hood compartments of the vehicle. Additionally, by locating the drop case/caliper assembly on a chassis coupled to the track shaft, the center of gravity of the vehicle is lowered, thereby improving drivability and handling. Another advantage is that by forming the drip case/caliper housing from a single piece, fewer components are needed to assemble the vehicle. This also reduces the weight of the vehicle. Additionally, moving the caliper housing into the tunnel frees up additional space under the hood and in the engine compartment area, thereby allowing a more efficient utilization of space. Locating the caliper housing into the tunnel also allows the brake to be more efficiently cooled because more airflow reaches the brake. Another advantage is that the braking disc can be made from a variety of materials, since the braking disc rotates at a slower rate when it is on the track shaft compared to being on the driven shaft.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

What is claimed is:

1. A unitary drop case and brake assembly for a personal recreational vehicle comprising:
a unitary housing having a drop case section and a caliper housing section; and
wherein the drop case section includes a wall separating an interior section and an exterior surface, and further wherein the caliper housing section extends outwardly from the exterior surface of the wall.

2. The assembly of claim 1, further including:
a braking arrangement housed within the caliper housing section including:
first and second opposed brake pads;
first and second pistons arranged to inwardly move the opposed brake pads towards each other when a force is applied to the pistons; and
a fastener arrangement holding the brake pad and pistons in the caliper housing section.

3. The brake assembly of claim 2 further including:
a braking disc coupled to a bearing mounted in the drop case section, wherein a portion of the braking disc passes between the brake pads.

4. The brake assembly of claim 3 further including:
a rotatable track shaft connected to the braking disc, wherein rotation of the track shaft is inhibited when the braking disc is engaged by the brake pads.

5. A snowmobile comprising:
a chassis having a tunnel section, the tunnel section including first and second opposed walls, the walls forming an interior section therebetween;
an opening in the first wall; and
a unitary housing having a drop case section and a caliper housing section mounted on the first wall, wherein the drop case section is outside the interior section and the caliper housing is received through the opening in the first wall and is inside the tunnel section.

6. The snowmobile of claim 5 further including:
a braking arrangement housed within the caliper housing section including:
first and second opposed brake pads;
first and second pistons arranged to inwardly move the opposed brake pads towards each other when a force is applied to the pistons; and
fastener arrangement holding the brake pad and pistons in the caliper housing section.

7. The snowmobile of claim 5, further including:
a braking disc coupled to a bearing mounted in the drop case section, wherein a portion of the brake disc passes between the brake pads.

8. The snowmobile of claim 6 further including:
a rotatable track shaft connected to the braking disc, wherein rotation of the track shaft is inhibited when the brake disc is engaged by the brake pads.

9. A housing assembly for a snowmobile including:
a unitary housing having a drop case portion and a caliper portion;
wherein the drop case portion includes:
an outer body defining an interior wall;
an interior section within the outer body for holding a sprocket arrangement with a lubricant sealed between the interior wall and a cover; and
one or more flanges extending laterally from the outer body, each flange having an opening for receiving and passing through a fastener; and
wherein the caliper portion extends outwardly from the drop case and is integrally formed with the outer body of the drop case.

10. The assembly of claim 9 further including:
a braking arrangement housed within the caliper portion including:
first and second opposed brake pads;
first and second pistons arranged to inwardly move the opposed brake pads towards each other when a force is applied to the pistons; and
a fastener arrangement holding the pistons and brake pads in the caliper portion section.

11. The assembly of claim 10, wherein the fastener arrangement includes:
a pair of bolts received into the caliper portion for holding the brake pads; and
an end cap received into and threaded portion of the caliper portion for holding the pistons.
